(19) United States
(12) Patent Application Publication
(10) Pub. No.: US 2010/0060445 A1
(43) Pub. Date: Mar. 11, 2010

(54) VEHICLE MULTIMEDIA TERMINAL FOR DISPLAYING CLOCK BY GLOBAL POSITIONING SYSTEM

(75) Inventor: Kee Hoon Choi, Gyeonggi-do (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR)

(21) Appl. No.: 12/342,665

(22) Filed: Dec. 23, 2008

(30) Foreign Application Priority Data
Sep. 9, 2008 (KR) 10-2008-0088825

(51) Int. Cl. B60Q 1/00

(52) U.S. Cl. 340/461

(57) ABSTRACT

A vehicle multimedia terminal for displaying a clock by a global positioning system (GPS) comprises: a GPS module that receives GPS time information; a clock button that applies a command for displaying current time information; a control unit that controls the display of the current time information with the GPS time information when the command is applied; and a display unit that displays the current time information under control of the control unit. The vehicle multimedia terminal provides accurate time information that works in conjunction with GPS time information, thereby facilitating convenience of users.

### CROSS-REFERENCE TO RELATED APPLICATION

This application claims under 35 U.S.C. §119(a) the benefit of Korean Patent Application No. 10-2008-0088825, filed on Sep. 9, 2008, the entire contents of which are incorporated herein by reference.

### BACKGROUND

The present invention relates to a vehicle multimedia terminal for displaying a clock by a global positioning system (GPS), and more specifically, to a vehicle multimedia terminal for displaying time information in conjunction with a GPS.

Multimedia devices such as audio, video, navigation (AVN) devices, which are embedded in a vehicle or detachable from a vehicle, provide services such as audio, video and navigation.

The multimedia devices also provide current time information to users using an electronic clock powered by a battery.

The electronic clock is reset when the battery is discharged, forcing a user to set the time again.

The above information disclosed in this Background section is only for enhancement of understanding of the background of the invention and therefore it may contain information that does not form the prior art that is already known in this country to a person of ordinary skill in the art.

### SUMMARY

In one aspect, the invention provides a vehicle multimedia terminal for displaying a clock by a global positioning system (GPS) that comprises: a GPS module that receives GPS time information; a clock button that applies a command for displaying current time information; a control unit that controls the display of the current time information with the GPS time information when the command is applied; and a display unit that displays the current time information under control of the control unit.

In one embodiment, the vehicle multimedia terminal may further comprise a speaker that outputs using a voice the current time information, current weather information such as outside temperature, or both under control of the control unit.

Preferably, the control unit controls the display of outside temperature information along with the current time information.

Preferably, the control unit displays the current time information as a pop-up type when the command is applied.

Preferably, when the command is applied, the control unit controls the current time information to be displayed with a priority over radio broadcasting, audio, and video data being outputted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features and advantages of the present invention will be apparent from or are set forth in more detail in the accompanying drawings, which are incorporated in and form a part of this specification, and the following Detailed Description, which together serve to explain by way of example of the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a diagram illustrating an external shape of a vehicle multimedia terminal for displaying a clock in conjunction with a GPS according to an embodiment of the present invention;

FIG. 2 is a diagram illustrating the construction of a vehicle multimedia terminal for displaying a clock in conjunction with a GPS according to an embodiment of the present invention;

FIGS. 3a and 3b are diagrams illustrating examples of the screen configuration for a clock setting according to an embodiment of the present invention; and

FIGS. 4a to 4j are diagrams illustrating examples of GPS time information display of a vehicle multimedia terminal according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

As described herein, the present invention includes a vehicle multimedia terminal for displaying a clock by a global positioning system (GPS) that comprises: a GPS module that receives GPS time information; a clock button that applies a command for displaying current time information; a control unit that controls the display of the current time information with the GPS time information when the command is applied; and a display unit that displays the current time information under control of the control unit.

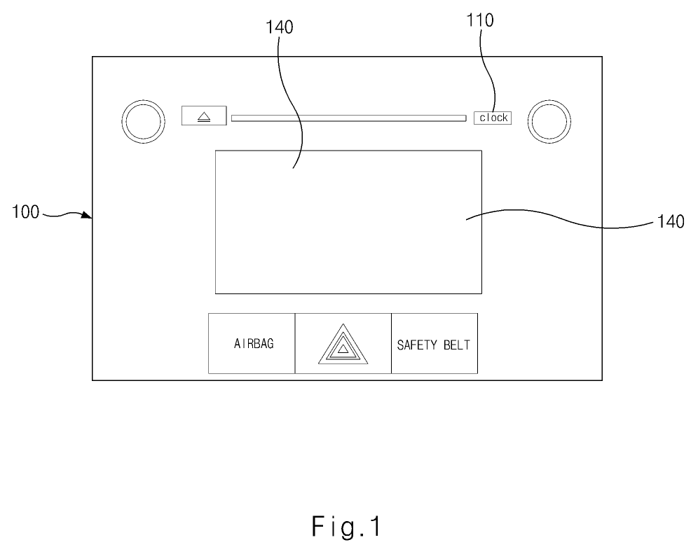

Hereinafter, vehicle multimedia terminals according to embodiments of the invention will be illustrated with reference to exemplary FIGS. 1 to 4i.

FIG. 1 is a diagram illustrating an external shape of a vehicle multimedia terminal for displaying a clock in conjunction with a GPS according to certain embodiments of the present invention.

According to exemplary embodiments, an AVN device 100 comprises a display unit 140 and a clock button 110 for selecting a time information display screen at the top of the display unit 140. It is possible to display a clock for each function by the clock button 110 with a one-touch button.

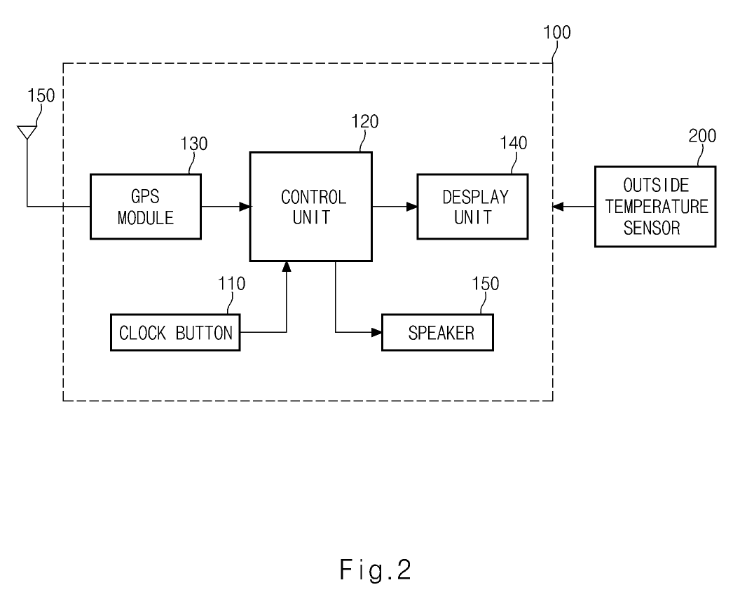

FIG. 2 is a diagram illustrating the construction of a vehicle multimedia terminal for displaying a clock by a GPS according to certain embodiments of the present invention.

According to exemplary embodiments, a vehicle multimedia terminal for displaying a clock that uses a GPS may comprise the clock button 110, a control unit 120, a GPS module 130, and a display unit 140. It may further comprise a speaker 150.

Depending on how many times the clock button 110 is pressed, a clock display screen in each function may be displayed differently. For example, a digital type clock may be displayed when the clock button 110 is pressed once, an analog type clock may be displayed when the clock button 110 is pressed twice, a digilog type clock may be displayed when the clock button 110 is pressed three times, and the clock and temperature may be displayed together when the clock button 110 is pressed four times.

Preferably, the current time information may be displayed through a pop-up when the clock button 110 is pressed once, and the pop-up may be closed when the clock button 110 is pressed again. The pop-up time may be set for, for example, 5 seconds, and the clock button 110 may be used in all screens. That is, the current time information is displayed as a pop-up type when a user pushes the clock button 110 while listening to the radio, using a navigation screen or playing a CD. In this way, the present invention increases the convenience for drivers because the drivers can check the time by an one-touch system using the clock button 110.

The control unit 120 controls the display of the current time information received through the GPS module 130 and outside temperature information received from an outside temperature sensor 200 on the display unit 140 when the clock button 110 is pressed. Preferably, the control unit 120 may perform control so as to output voice through the speaker 150 while displaying the current time information and the outside temperature information on the display unit 140.

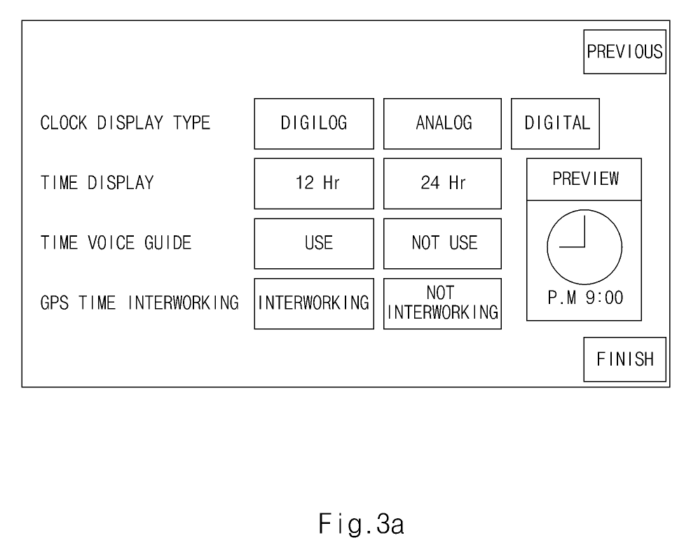

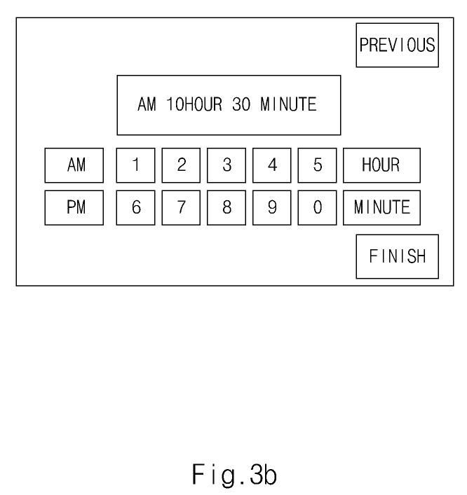

As shown in FIG. 3a, the control unit 120 receives user's selection from the digilog, analog and digital modes for a clock display type, decides whether the time display type is displayed as a 12-time-unit or 24-time-unit, and determines whether a time (and/or weather) voice guide is used and whether a GPS is used for time setting. If the GPS is not used, a time adjust mode as shown in FIG. 3b is activated, so that the control unit 120 receives the current time information from a user.

The GPS module 130 receives a GPS signal, which includes time information, from a satellite.

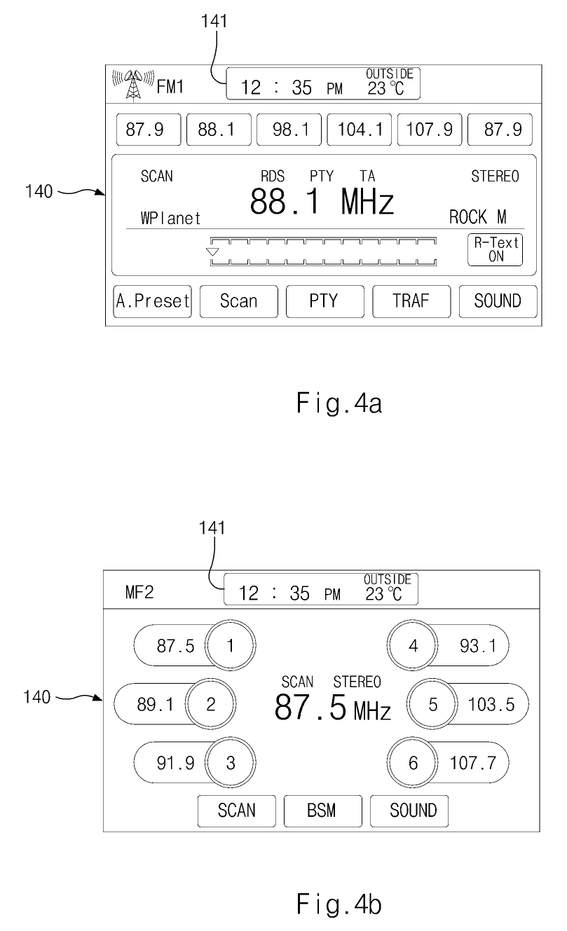

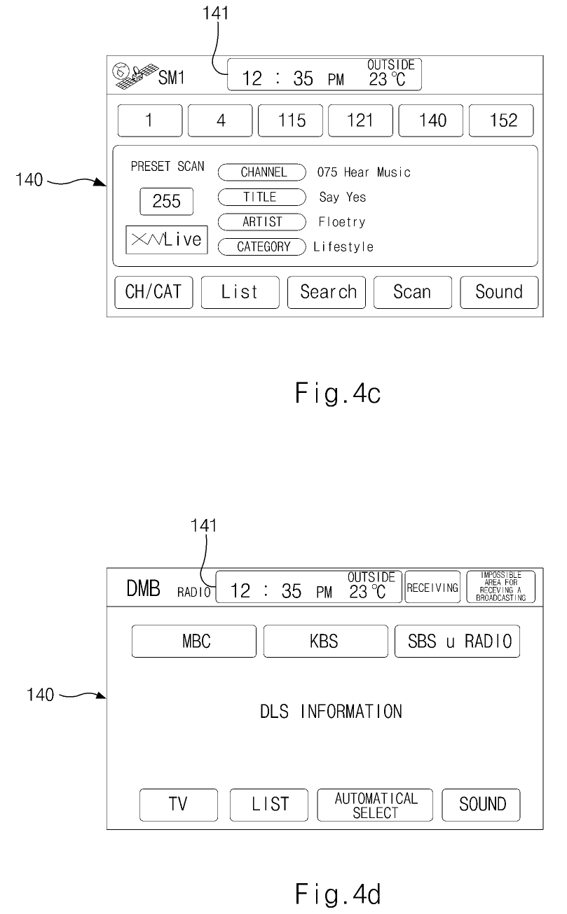

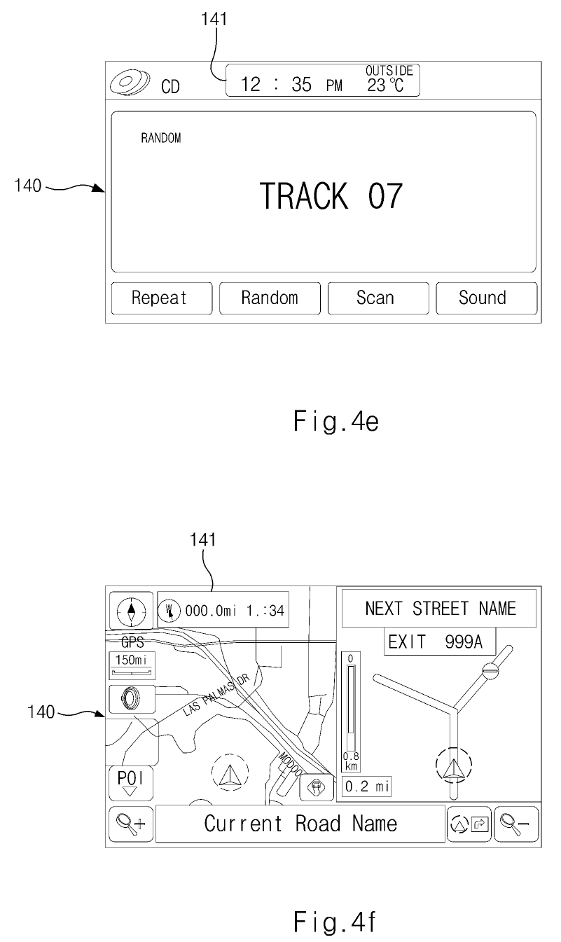

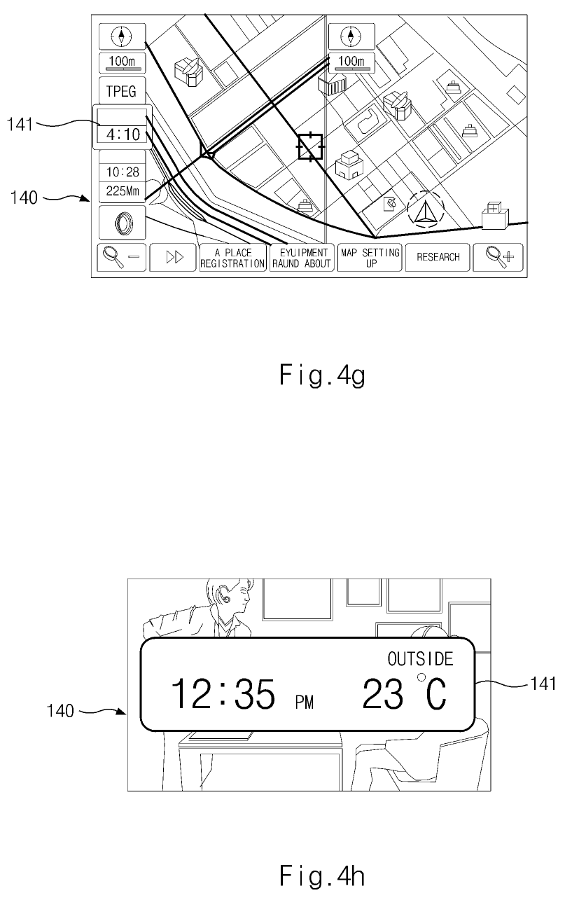

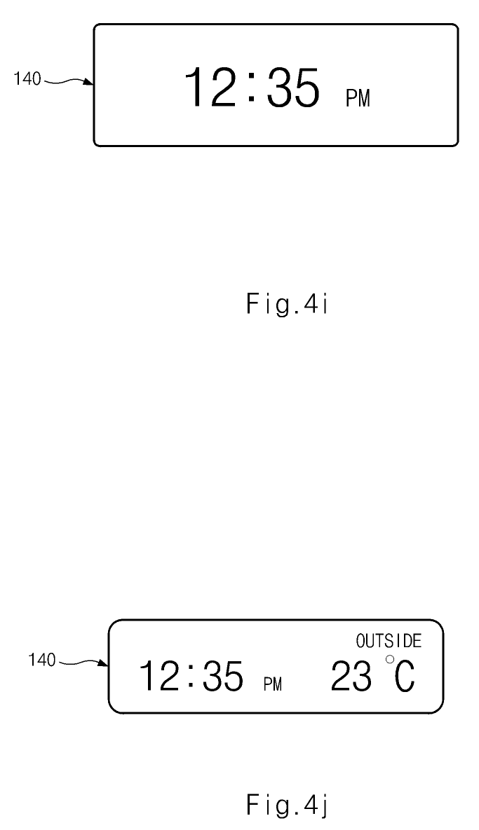

The display unit 140 displays a time information screen depending on control of the control unit 120 as shown in FIGS. 4a to 4j. FIG. 4a shows an example where the selected FM radio channel (e.g., 88.1 MHz) information is displayed on the display unit 140 and the current time information 141 is displayed at the top of the display unit 140 when a user listens to FM radio broadcasting. FIG. 4b shows an example of different screen configuration and time information display when a user listens to FM radio broadcasting. FIG. 4c shows an example where the selected XM satellite broadcasting channel information (e.g., 075 Hear Music) is displayed on the display unit 140 and the current time information 141 is displayed at the top of the display unit 140 when a user listens to XM satellite broadcasting. FIG. 4d shows an example of a screen configuration and time information 141 display when a user listens to DMB satellite broadcasting. FIG. 4e shows an example of a screen configuration and time information 141 display when a user uses a CD player.

FIG. 4f shows an example where the current time information 141 is displayed at the top portion of the display unit 140 when navigation information is displayed on the screen of the display unit 140. FIG. 4g shows an example where the current time information 141 is displayed on the left side of the display unit 140 when navigation information is displayed on the screen of the display unit 140. FIG. 4h shows an example where the current time information 141 is displayed as a pop-up type when the clock button 110 is pressed in video playing. FIG. 4i shows an example where the current time information is displayed on the whole screen of the display unit 140. FIG. 4j shows an example where the current time information and outside temperature information are displayed together on the whole screen of the display unit 140.

When the AVN device 100 is powered off, the display unit 140 converts the whole screen into the time display mode. The time providing screen can be preset as an analog type, a digital type or a digilog type by a user.

As described above, the vehicle multimedia terminal of the present invention receives a GPS signal from a satellite to provide time information in conjunction with a GPS. As a result, when the time information is reset due to discharge of a battery, the vehicle multimedia terminal of the present invention can provide the current time information for a driver according to the time information in conjunction with the GPS although a user does not set the time information again.

What is claimed is:

1. A vehicle multimedia terminal for displaying a clock by a global positioning system (GPS), the terminal comprising:
a GPS module that receives GPS time information;
a clock button that applies a command for displaying current time information;
a control unit that controls the display of the current time information with the GPS time information when the command is applied; and
a display unit that displays the current time information under control of the control unit.

2. The vehicle multimedia terminal according to claim 1, further comprising a speaker that outputs using a voice at least one of the current time information and current weather information under control of the control unit.

3. The vehicle multimedia terminal according to claim 1, wherein the control unit controls the display of outside temperature information with the current time information.

4. The vehicle multimedia terminal according to claim 1, wherein the control unit displays the current time information as a pop-up type when the command is applied.

5. The vehicle multimedia terminal according to claim 4, wherein when the command is applied, the control unit controls the current time information to be displayed with a priority over radio broadcasting, audio, and video data being outputted.
